(19) United States
(12) Patent Application Publication
(10) Pub. No.: US 2015/0071714 A1
(43) Pub. Date: Mar. 12, 2015

(54) TIRE TREAD GEOREINFORCING ELEMENTS AND SYSTEMS

(71) Applicant: ARMATERRA, INC., Reno, NV (US)

(72) Inventor: Michael J. Merrill, Reno, NV (US)

(21) Appl. No.: 14/391,697

(22) PCT Filed: Apr. 8, 2013
(86) PCT No.: PCT/US13/35677

§ 371 Date: Oct. 9, 2014

Related U.S. Application Data
(60) Provisional application No. 61/621,932, filed on Apr. 9, 2012.

(51) Int. Cl. E02D 17/20; F16B 2/06; E02D 29/02

(52) U.S. Cl. CPC E02D 17/20; E02D 29/025; F16B 2/065
USPC 405/284; 24/569

(57) ABSTRACT

The present disclosure provides embodiments directed to earth reinforcement. The present embodiments can be made from used tire threads or equivalent new material. Used tires are particularly advantageous as they are relatively inexpensive materials and results in the added collateral benefit of repurposing materials that would otherwise be destined for disposal in landfills. The embodiments are easily constructed, can be made from non-corrosive materials, and can be assembled at the site of deployment.

### CROSS REFERENCE TO RELATED APPLICATIONS

This application claims the benefit of U.S. Provisional Patent Application No. 61/621,932, filed Apr. 9, 2012, the disclosure of which is incorporated herein by reference in its entirety.

### TECHNICAL FIELD

The present disclosure provides embodiments directed to both lateral and vertical earth reinforcement. The present embodiments can be made from new material or used tires. Used tires are particularly advantageous as they are relatively inexpensive and results in the added collateral benefit of repurposing materials that would otherwise be destined for disposal in landfills. The embodiments are easily constructed, can be made from non-corrosive materials, and can be assembled at the site of deployment.

### BACKGROUND

Man has planned and constructed earth embankments and retaining walls since the onset of his need to create and construct. Early builders recognized the value of reinforcing the material behind retaining walls to minimize the pressures on those walls. The Babylonians reinforced the soils behind their retaining walls with reeds; the Romans used reeds and papyrus; and the Chinese used sticks and other simple materials in backfilling portions of the Great Wall.

The progress of science brought new technology and new ways of supporting embankments. Reinforced concrete and structural steel became the principal tools in retaining earth; these methods were expensive. As an alternative to large, costly concrete and steel earth retaining structures, the French developed a system known as Reinforced Earth (Vidal, 1969, U.S. Pat. No. 3,421,346), where flat steel straps were used as reinforcing elements. Those elements were buried in the backfill behind a retaining wall facing to provide additional shear and tensile strength to the soil and were connected to the wall facing. Davis (1984, U.S. Pat. No. 4,449,857), continuing earlier work by CalTrans (Forsyth, 1978), developed Retained Earth, using steel rods fashioned in the shape of a ladder as reinforcing elements. Hilfiker (1982, U.S. Pat. No. 4,324,508) developed an earth reinforcing system using welded wire mats as reinforcing elements. These reinforced embankments earned the generic title of mechanically stabilized embankments (MSE).

The Tensar Corporation developed concurrently high density plastic webbing, now known generically as geogrid, which was used as reinforcing elements in the internal reinforcement of steep fill slopes. Woven fabric geogrids coated with plastic entered the market shortly thereafter. Modular blocks soon became the facing elements of choice for non-highway projects and geogrid became its companion earth reinforcing element (Forsburg, 1989, U.S. Pat. No. 4,825,619), (Miner, 1990, U.S. Pat. No. 4,936,713), (Egan, et al, 1999, U.S. Pat. No. 5,911,539). Geogrid also was combined with L-shaped welded wire basket facings for use in constructing temporary retaining walls and embankments during construction of highway overpass projects, by-pass projects, grade separations and other structures requiring temporary retaining walls or embankments.

Corrosion of steel reinforcing elements buried in soil has long been a concern. Galvanization of the steel was adopted as a preventive measure, then the requirement that the backfill surrounding the steel reinforcing elements consist of a “special” (neutral pH) backfill was added. Later work by Sala et al. (1992, U.S. Pat. No. 5,169,266) and studies by private consultants have revealed a significant potential for corrosion of galvanized steel reinforcing elements buried in special backfill where (1) high alkali soils are present and/or (2) salting and sanding of roads occur above or adjacent to MSE.

Steel reinforcing elements are considered “non-extensible;” i.e. the modulus of elasticity of the steel reinforcing element is greater than the modulus of elasticity of the surrounding backfill. Conversely, geogrid is considered an “extensible” reinforcing element. The design methodology differs between the two types of reinforcing elements, which results in a greater amount of geogrid required than steel reinforcing for similar MSE. Thus, the materials cost differential between steel reinforcing elements and geogrid reinforcing elements can be negated by the need for a significantly greater amount of geogrid.

A temporary MSE, which generally has a life of one to three years, often is demolished and the materials (wire basket facing, geogrid and filter cloth) are hauled to a landfill. The costs of hauling those materials to a landfill can approach the cost of the materials, and filling the landfills with those materials is not an environmentally sensitive choice.

The present disclosure provides embodiments of tire tread or tread-like georeinforcing elements, which are at least as strong and durable as those currently in use. The present embodiments incorporate connectors that enable the assembly of the tire tread georeinforcing elements where they are to be deployed. In addition, the embodiments can be made from relatively inexpensive materials, are easily constructed, and can be made from non-corrosive materials.

### BRIEF DESCRIPTION OF THE DRAWINGS

FIG. 1 is a sectional view of a tire tread connector comprising two tread clamp fasteners and a clamp bolt;

FIG. 2 is a sectional view of a tire tread connector comprising a spacer, load bars and clamps;

FIG. 3 is a sectional view of a tire tread linear friction connector;

FIG. 4 is a sectional view of a MSE-tire tread friction connector;

FIG. 5 is a sectional view of a modular block/crib wall-tire tread friction connector; and

FIG. 6 is a sectional view of a tire facing-tire tread friction connector;

FIG. 7A is a sectional view of a side rail connector;

FIG. 7B is a centered plan view of the side rail connector; and

FIG. 7C is a sectional view of the side rail connector with tire treads installed therein.

### DETAILED DESCRIPTION OF ILLUSTRATIVE EMBODIMENTS

The present disclosure provides embodiments directed to earth georeinforcing (herein referred to as “georeinforcing”) elements. The present embodiments can be made from used tire treads or from new materials that are similar in size, shape and composition to used tire treads (hereafter included in the term “tire treads”). Used tires treads are a particularly advantageous starting material as they are relatively inexpensive, and results in the added collateral benefit of repurposing materials that would otherwise be destined for disposal in landfills.

The present embodiments can be assembled at a dedicated manufacturing facility, or optionally can be assembled at the site of deployment, thereby providing options for deployment of the embodiments in accordance with the needs of the user, and the location for the deployment.

The present embodiments can be made from non-corrosive materials, thereby eliminating the need for anti-corrosive measures, such as having to encapsulate the deployed georeinforcing elements in treated pH neutral backfill. This results in a faster and more cost-efficient deployment process.

The present embodiments can be used to reinforce material behind retaining walls to minimize the pressure on those walls. The embodiments can be attached to the retaining walls or can also be deployed unattached to the retaining wall.

The present embodiments can be deployed to stabilize a temporary retaining wall or other earth structure. When the temporary wall or earth structure is no longer needed, and dismantled, the embodiments can be recovered and reused.

The present embodiments provide earth reinforcing (hereafter referred to “georeinforcing”) elements and systems. The georeinforcing elements are made from tire treads. The tire georeinforcing elements utilize friction between the surfaces of the georeinforcing elements and the surrounding particular matter to help stabilize a MSE. Moreover it has been discovered that there is a distinct strength advantage to be realized by manufacturing georeinforcing elements entirely from tire treads. Instrumental in the manufacture of tire tread georeinforcing elements are suitable tire tread connectors for adjoining tire treads together and maintaining their connection after the tire tread georeinforcing element is deployed.

An embodiment of the present disclosure provides a vertical georeinforcing element comprising a plurality of tire treads. A used tire tread is generally obtained from a tire by separating the sidewalls of the tire from the tire tread surface. The tire tread surface is then cut across the treads resulting in an essentially flat, rectangular tire tread. Multiple tire treads can be adjoined lengthwise by various fastener systems end to end thereby forming a tire tread georeinforcing element. As can be readily appreciated, a tire tread georeinforcing element can be made to any desired length by adjoining any number of tire treads. If a resulting tire tread georeinforcing element is too long because of the addition of one tire tread, the excess length can be trimmed to provide a tire tread band georeinforcing element of the desired length. Tire treads can be adjoined to other tire treads using connectors, fasteners or other mechanical implements, such as non-corrosive looping wire or bolts.

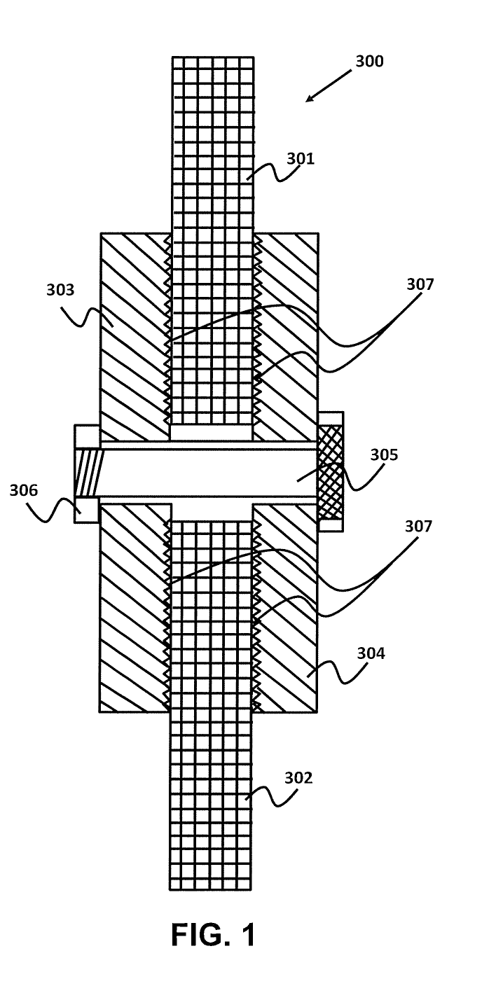

An embodiment of the present disclosure provides a tire tread connector that can be used to make a tire tread georeinforcing element in a manufacturing facility or at the location of deployment. Two adjacent tire treads are adjoined end to end by the connector. FIG. 1 is a sectional view of a first tire tread 301 and a second tire tread 302 placed end-to-end and adjoined by means of one or more non-corrosive tire tread clamp connectors 300. One end of a first tire tread 301 is placed adjacent to one end of a second tire tread 302. The serrated edge 307 of a first clamp piece 303 of tire tread clamp connector 300 is placed on a first side of first tire tread 301 and adjacent tire tread 302. The serrated edge 307 of a second clamp piece 304 of tire tread clamp connector 300 is placed on a second side of first tire tread 301 and adjacent tire tread 302; the first side opposite the second side. A non-corrosive clamp bolt 305 is placed through holes in first clamp piece 303 and second clamp piece 304 and is secured by clamp bolt 306.

The fastener system depicted in FIG. 1 is particular effective for vertical placement of tire tread georeinforcing elements, such as in existing levies. The method and manner of insertion of the georeinforcing element can vary, such as drilling a vertical hole in the levy at various points and inserting a georeinforcing element into each hole, then backfilling the remainder of the whole. Alternatively, pneumatic insertion devices can be used to essentially drive the georeinforcing elements into the levy from the upper surface of the levy. Newly built levies, however, need not rely on vertical georeinforcing elements and could also be built using lateral georeinforcing elements, or even a network of mixed vertical and lateral georeinforcing elements.

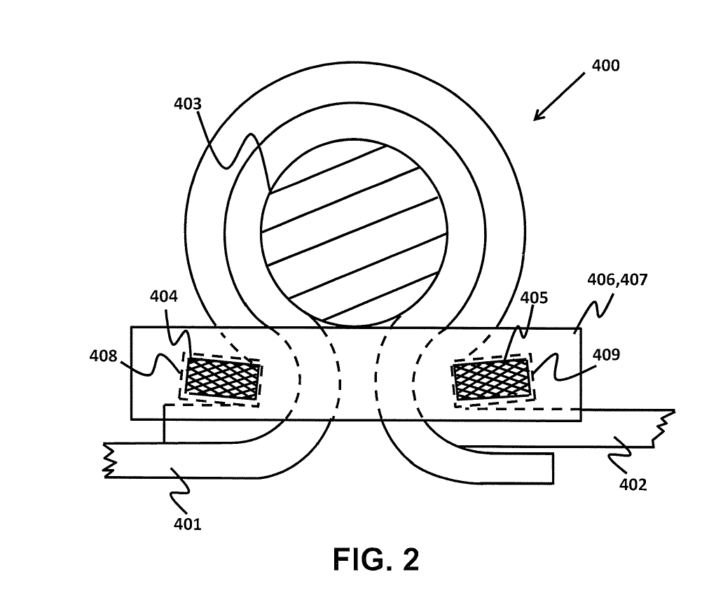

Another embodiment of the present disclosure provides a tire tread connector that can be used to make a tire tread georeinforcing element in a manufacturing facility or at the location of deployment. Two adjacent tire treads are adjoined and maintained in an overlapping fashion using the connector. FIG. 2 is a sectional view of a tire tread wrap friction connector 400 used to adjoin two tire treads 401 and 402. A first tire tread 401 wraps partially around a spacer 403 of any size, shape and non-corrosive material appropriate for the intended use, with the short end of first tire tread 401 extending below the spacer 403 and the long section of first tire tread 401 extending horizontally away from the bottom of the spacer 403. The second tire tread 402 wraps over and at least partially around, and parallel to, the first tire tread 401 with the short end of the second tire tread 402 extending below the spacer 403 and the long section of second tire tread 402 extending horizontally away from the bottom of the spacer 403 in a direction opposite that of the long section of the first tire tread 401. The first tire tread 401 and the second tire tread 402 are fixed in the above-described configuration by a first non-corrosive load bar 404 on one side of the parallel tire treads 401 and 402 beneath the spacer 403 and by a second non-corrosive load bar 405 on the opposite side of the parallel tire treads 401 and 402 beneath the spacer 403. Load bars 404 and 405 are held in place by two non-corrosive load bar clamps 406 and 407, each comprising a planar object of any appropriate size and shape, with an opening (FIG. 2 shows two example openings 408 and 409) near each end of load bar clamps 406 and 407, which fit over each end of each load bar 404 and 405. The primary axes of the load bars 404 and 405 are perpendicular to the lengths of first and second tire treads 401 and 402 and are parallel to the axis of the spacer 403. The primary axes of the load bar clamps 406 and 407 are perpendicular to the primary axes of the load bars 404 and 405. Tensile forces on the first tire tread 401 and the second tire tread 402 results in friction between the first tire tread 401 and the second tire tread 402, between the first tire tread 401 and its adjacent load bar 405, and between the second tire tread 402 and its adjacent load bar 404. These frictional forces in multiple directions prevent movement and separation of the first tire tread 401 and the second tire tread 402.

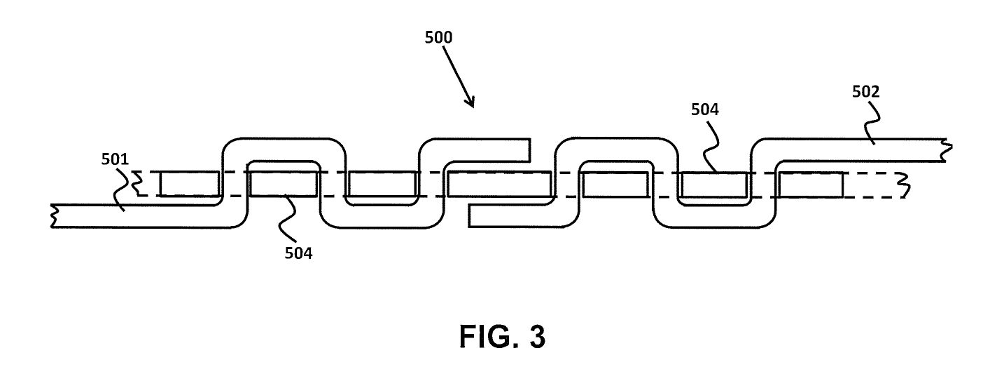

Another embodiment of the present disclosure provides a tire tread connector that can be used to make a tire tread georeinforcing element in a manufacturing facility or at the location of deployment. Two adjacent tire treads are adjoined and maintained in an overlapping fashion using the connector. FIG. 3 is a sectional view of a tire tread linear friction connecter 500 used to adjoin two tire treads 501 and 502. A tire tread linear friction connector is a manufactured non-corrosive piece comprising two end pieces (not shown) of any appropriate size and shape attached to a plurality of cross pieces 504 of any appropriate size and shape. The cross pieces 504 are spaced apart from one another to accommodate a first tire tread 501 and a second tire tread 502. The first tire tread 501 is wound in a serpentine fashion through the openings between the cross pieces 504 in one half of the tire tread linear friction connector 500. The second tire tread 502 is wound in a serpentine fashion through the openings between the cross pieces 504 in the opposite half of the tire tread linear friction connector 500. The friction between the first tire tread 501 and the cross pieces 504 with which the first tire tread 501 engages, and the friction between the second tire tread 502 and the cross pieces 504 with which the second tire tread 502 engages prevent movement of the first tire tread 501 relative to the second tire tread 502.

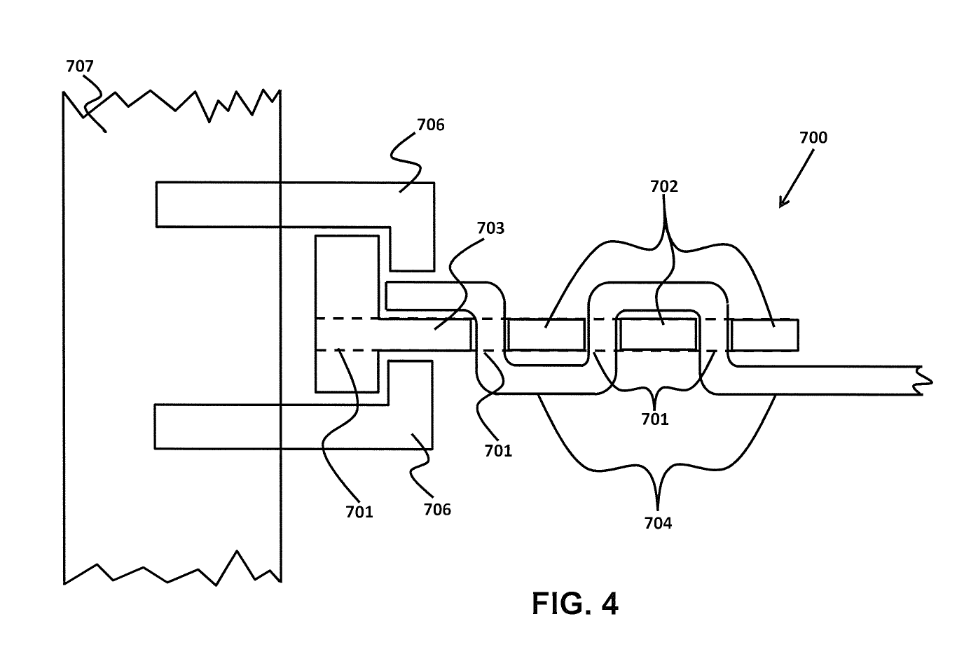

Yet another embodiment provides a connector piece which connects one end of a tire tread georeinforcing element to a mechanically stabilized embankment (MSE) facing panel. FIG. 4 illustrates a cross sectional view of a MSE-tire tread friction connector 700. The MSE-tire tread connector 700 is a manufactured, non-corrosive piece comprising two sides 701 spanned by, and connected to, any appropriate cross pieces 702 which are perpendicular to sides 701 and are spaced apart from each other any appropriate distance. A first cross piece 703 is located on one end of the MSE-tire tread friction connector 700. The cross piece 703 extends vertically upward and downward and perpendicular to MSE-tire tread friction connector 700. One end of a first tire tread 704 in a georeinforcing element is inserted into the spaces between cross pieces 702 in a serpentine fashion. The first cross piece 703 mates with two non-corrosive, angle shaped tabs 706 protruding from the read side of a manufactured facing panel 707. The ends of the angle shaped tabs 706 opposite the protruding ends are embedded in the solid MSE facing panel 707 and anchored by any appropriate means.

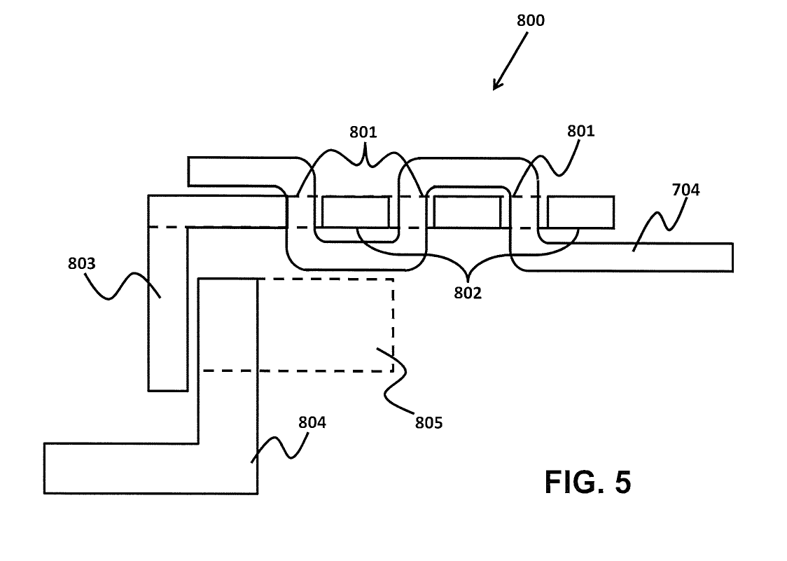

Yet another embodiment provides a connector piece which connects one end of a tire tread georeinforcing element to a modular block retaining wall or to a crib wall. FIG. 5 illustrates a cross-section view of a modular block/crib wall-tire tread friction connector 800. A modular block/crib wall-tire tread connector 800 is a manufactured, non-corrosive piece comprising two sides 801 spanned by, and connected to, any appropriate cross pieces 802 which are perpendicular to sides 801 and are spaced apart from each other any appropriate distance. A first cross piece 803 is located on one end of modular block/crib wall-tire tread friction connector 800; that first cross piece 803 has a leg which extends vertically below, and perpendicular to, the front edge of first cross piece 803. The vertical leg of first cross piece 803 bears against the rear of the core hole of any modular block 804 or, in the case of connecting to a crib wall, bears against the front face of a crib wall front stretcher 805. One end of a first tire tread 704 of a georeinforcing element is inserted into the spaces between cross pieces 802 in a serpentine fashion.

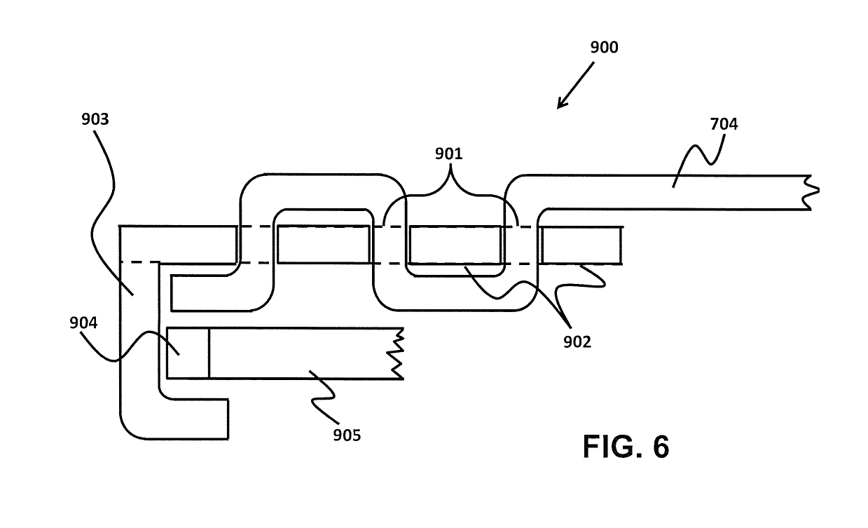

Still another embodiment provides a piece which connects one end of a tire tread georeinforcing element to whole tires used as facing elements for temporary retaining walls. FIG. 6 shows a cross-section view of a tire facing-tire tread friction connector 900. The tire facing-tire tread connector 900 is a manufactured, non-corrosive piece comprising two sides 901 spanned by, and connected to, any appropriate cross pieces 902 which are perpendicular to sides 901 and are spaced apart from each other any appropriate distance. A first cross piece 903 is located on one end of tire facing-tire tread friction connector 900. The first cross piece 903 extends vertically below, and perpendicular to, the front edge of cross pieces 902, then horizontally back toward the opposite end of cross pieces 902. The first cross piece 903 bears against the inside portion of the bead 904 of whole tire 905. One end of a first tire tread 704 of a tire tread georeinforcing element is inserted into the spaces between cross pieces 902 in a serpentine fashion.

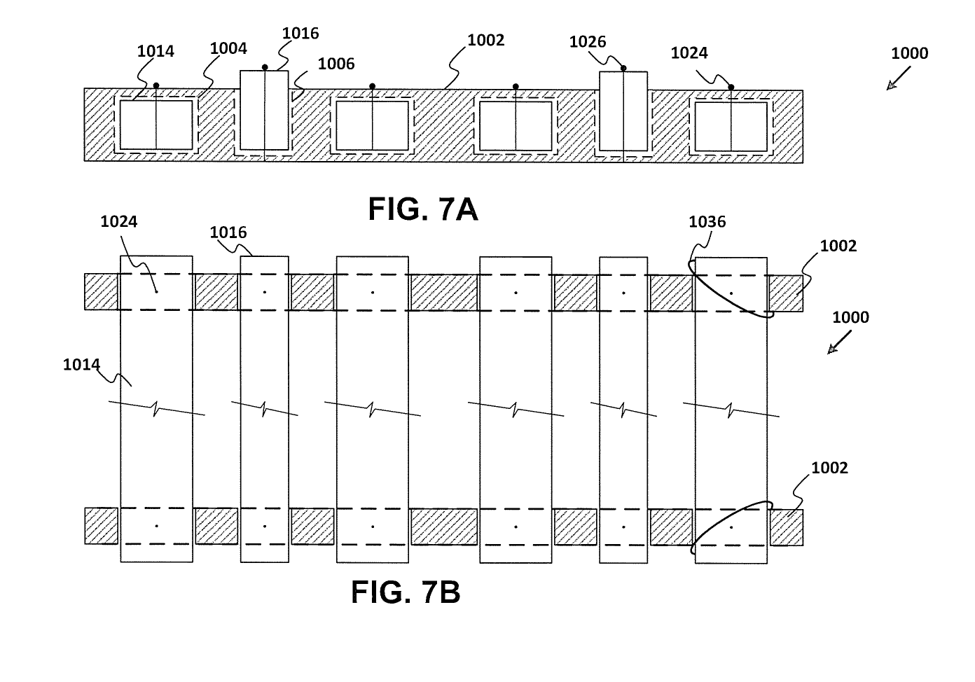

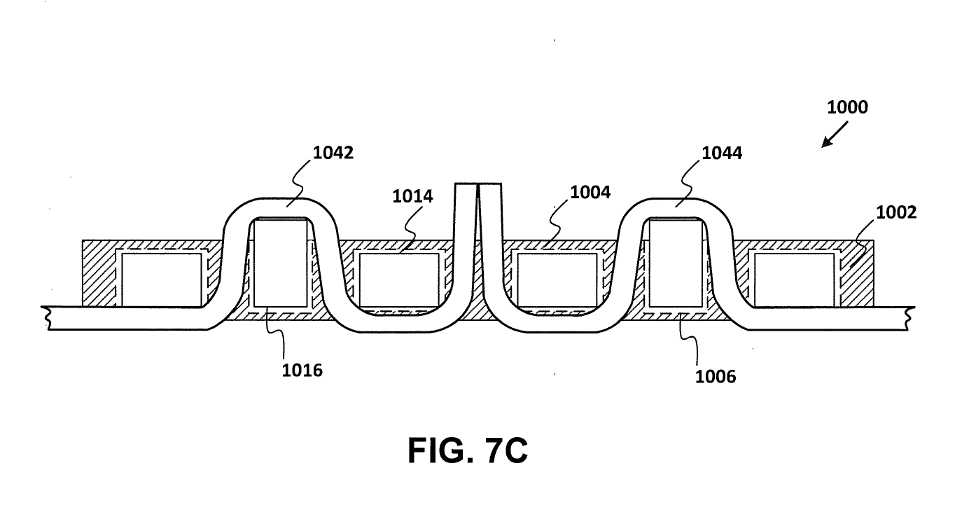

Another embodiment of the present disclosure provides a tire tread connector that can be used to make a tire tread georeinforcing element in a manufacturing facility or at the location of deployment. At least two adjacent tire treads are adjoined and maintained in an overlapping fashion using the connector. FIGS. 7A and 7B illustrate a side rail connector 1000 configured to adjoin the tire treads and FIG. 7C illustrates two tire treads 1042 and 1044 adjoined in the side rail connector 1000.

Referring to FIG. 7A, a sectional view of the side rail connector 1000 is illustrated. The side rail connector 1000 comprises a number of side rails 1002 (two side rails 1002 are shown in FIG. 7B) that are configured to secure a series of similar cross-pieces 1014 and 1016 around which tire treads can be installed (two tire treads 1042 and 1044 wrapped in a serpentine configuration around the cross-pieces are shown in FIG. 7C). Each side rail 1002 may include consecutive sets of openings 1004 and cavities 1006 forming a predefined pattern in which the cross-pieces 1014 and 1016, respectfully, can be installed.

Two consecutive sets are shown in FIG. 7A, in each of which there are two openings 1004 and a cavity 1006 in between the two openings 1004. This pattern could be reversed, such as two cavities 1006 on either side of an opening 1004, or some other combination of openings and cavities could be used. As shown in FIG. 7A, the pattern of opening-cavity-opening is repeated across the two sets. Further, the two sets may be separated at a predefined distance that allows sections of at least two tire treads to be adjacently installed in the space partially defined by the distance. For example, the distance between an end of one opening 1004 in one set and an end of another opening 1004 in the consecutive set may substantially be around 1.25 inches, where in this example, the two openings 1004 are consecutive and the two ends face each other.

Within a single set, consecutive elements of the pattern (an element being an opening or a cavity) may be separated at a predefined distance that allows a section of at least one tire tread to be installed in the space partially defined by the distance. For example, the distance between an end of one opening 1004 and an end of a cavity 1006 may substantially be around 0.75 inches, where in this example, the opening and the cavity are consecutive and the two ends face each other. Further, the distance between an end of the set and a facing end of the side rail 1002 may be predefined such that this distance is minimized to avoid unnecessary material while also maintaining the structural integrity of the side rail connector 1000. Continuing with the previous example, an end of an opening 1004 to a facing end of the side rail 1002 may substantially be around 0.5 inches, where in this example, the opening is the most adjacent element within the set to the end of the side rail.

Within a single set and/or across the two sets, bottom surfaces of the elements (the openings 1004 and the cavities 1006) may belong to the same surface plan. In an example, the bottom surfaces can be set at substantially 0.25 inches from the bottom surface of the side rail 1002. Likewise, top surfaces of the openings 1004 may belong to a same first surface plan while, top surfaces of the cavities 1006 may belong to a same second surface plan. However, the first and second surface plans may be different. Continuing with the previous example, each of the openings 1004 may be centered between the top and bottom surfaces of the side rail 1002. As such, the top surface of the openings may be at substantially 0.25 inches from the top surface of the side rail 1002. In comparison, the top surface of each of the cavity 1006 may be aligned with the top surface of the side rail 1002 (i.e., the distance between these two surfaces is substantially 0 inches). As used herein, a top surface of a cavity 1006 is intended to illustrate an imaginary line that substantially defines the shape of that surface and is not intended to illustrate a physical surface or edge.

Considering an opening 1004 and a cavity 1006, these two elements may be configured to support cross-pieces that have the same dimensions but that are installed in different configurations. For example, the opening 1004 may have dimensions of substantially 1 inch in length, 0.5 inches in height, and the same width of the side rail 1002 (which may be at substantially 0.5 inches in this example). In comparison, the cavity 1006 may have dimensions of substantially 0.5 inches in length, 0.75 inches in height, and the same width of the side rail 1002. Such dimensioning allows the installation of cross-pieces of the same size but in horizontal and vertical configurations relative to the side rail 1002. Put differently, the cross-piece 1014 installed in opening 1004 and the cross-piece 1016 installed in the cavity 1006 can have the same overall dimensions but can be installed perpendicularly relative to each other such that the cross-piece 1016 is rotated ninety degrees relative to the cross-piece 1014. These overall dimensions may be slightly smaller than or substantially the same as the dimensions of the opening 1004 such that the space between the edges of the opening 1004 and the cross-piece 1014 and the space between the edges of the cavity 1006 and the cross-piece 1016 are minimized when the cross pieces are installed. This minimization in space allows a secure installation of the cross-pieces 1014 and 1016 in the side rail 1002. As such, the dimensions of the cross-piece 1014 may be 1 inch in width, 0.5 inches in height, and a predefined length that exceeds the width of the side rail 1002 (as discussed herein below with regard to FIG. 7B, this length can be set to 10.5 inches to allow a tire tread to be installed around the cross-piece 1014). Likewise, and to be perpendicular to the cross-piece 1014, the cross-piece 1016 has a width of 0.5 inches, a height of 1 inch, and the same predefined length.

Various mechanisms may be used to further secure the cross-pieces 1014 and 1016 to the side rail 1002. For example, after inserting the cross-piece 1014 in the opening 1004, a pin 1024 may be inserted from the top surface of the side rail 1002 through the body of the cross-section 1014. Likewise, after inserting the cross-piece 1016 in the cavity 1006, a similar pin 1026 (but which may have a different length than that of the pin 1024) may be inserted from the top surface of the cross-piece 1016, through the body of the cross-piece 1016, exiting the bottom surface of the cross-piece 1016, and entering the body of the side rail 1002. The pins 1024 and 1016 may be permanently installed (e.g., not removed after the installation of the tire treads). In such a case, these pins may be made of non-corrosive materials. Alternatively, the pins 1024 and 1016 may be temporarily installed (e.g., removed after the installation of the tire treads as shown in FIG. 7C). In such a case, these pins need not be made of non-corrosive materials (e.g., can be made using 1/16″ metal pins). Other securing mechanisms may also be used in conjunction with or instead of the pins 1024 and 1026 such as screws, bolts, rods, loopy wires, etc. (FIG. 7B illustrates the use of loopy wires 1036 in conjunction with pins 1024). If the relative dimensions of the cross-pieces and side rails are such that the woven tire treads fit snuggle between the cross-pieces, there may be no need for further securing the cross-pieces to the side rails because once the tire treads are woven through, the side rails may be inconsequential.

Referring to FIG. 7B, a centered plan view of the side rail connector 1000 is illustrated. Although the side rail connector 1000 is shown as comprising two parallel side rails 1002, a larger number of side rails can be used, or even a single, centered side rail could be used. For example, the side rail connector 1000 may include three parallel side rails 1002 aligned in parallel such that each cross-piece 1014 is installed in three parallel openings 1004 and each cross-piece 1016 is installed in three parallel cavities 1006.

As shown in FIG. 7B, the two side rails 1002 are aligned such their horizontal axes are parallel to each other and such that their respective openings 1004 and 1006 are in parallel positions. Further, when the cross-pieces 1014 and 1016 are installed in these openings 1004 and 1006, respectively, the cross-pieces have horizontal axes that are parallel to each other and that are also perpendicular to the horizontal axes of the side rails 1002.

The distance between the two side rails 1002 can be set to be equal or greater than a size (e.g., width) of at least a tire tread that may be installed. For example, the distance can be substantially 9 inches for certain sizes of tires and more or less for others. This distance can be used to partially define the length of the cross-pieces 1014 and 1016. This length can be based on the distance between the two side rails 1002, the width of each side rail 1002, and a margin that allows the cross-pieces to exit each side rail 1002 from the side not facing the other side rail. This margin can be set to be equal the distance between the bottom surface of an opening 1004/cavity 1006 and the bottom surface of a side rail 1002 (e.g., 0.25 inches in the example provided in FIG. 7A). As such, with a 9 inch distance between the two side rails 1002, a 0.5 inch wide side rail, and a margin of 0.25 inches, each cross-piece may have a length of at least 10.5 inches.

As described above, the side rail 1002 may include two sets of elements. Each set may include a pattern of two openings 1004 and a cavity 1006 therebetween. Each opening 1004 may allow a cross-section 1014 to be installed and secured to the side rail 1002. Likewise, each cavity 1006 may allow a cross-section 1016 to be installed and secured to the side rail 1002. The openings 1004 and 1006 are configured such that the cross-sections 1014 and 1016 have the same overall dimensions and are installed in a ninety degree rotation relatively to each other. The openings 1014 and the cavity 1016 of one set are spaced apart to allow the installation of at least a tire tread. The two sets are spaced apart to allow two tire treads, each being installed in one of the two sets, to be adjoined together. The overall dimensions of the side rail 1002 are substantially 0.5 inches in width, 1 inch in height and 10.25 inches in length. These components of the side rail connector 1000 may be made of non-corrosive materials appropriate for the intended use. One having ordinary skill in the art will appreciate that various other configurations of the side rail connector 1000 are possible. For example, as noted above, other patterns of elements may be used (e.g., opening-opening-opening, cavity-opening-cavity, etc.), more or less than three elements may be used in a set, more than two sets may be used, the sets need not have the same pattern, the elements need not have rectangular shapes (e.g., the openings and cavities can have square shapes, can be triangular, etc.). Further, the provided examples of sizes, shapes, distances, dimensions, and compositions are illustrative. Other sizes, shapes, distances, dimensions, and compositions may be implemented depending on a desired configuration of the side rail connector 1000 and the type of tires being used. The specific implementation may depend on georeinforcing requirements, the installed tire treads, and the like and may be customized to realize a compact and cost efficient connector 1000 while also maintaining its structural integrity.

Referring to FIG. 7C, a sectional view of the side rail connector 1000 is illustrated with two tire treads installed therein. A first tire tread 1042 wraps in a serpentine fashion around the cross-pieces 1014 and 1016 in the one half (the left side as illustrated in FIG. 7C) of the side rail connector 1000 (e.g., in the first set of the two consecutive sets, the first set including two openings 1004 and a cavity 1006). The short end of the first tire tread 1042 extends above the side rail connector 1000 and is located in the space partially defined between the first set and the second set. The long section of the first tire tread 1042 extends horizontally away from the bottom of the side rail connector 1000. Likewise, a second tire tread 1044 wraps in a serpentine fashion around the cross-pieces 1014 and 1016 in the opposite half (the right side as illustrated in FIG. 7C) of the side rail connector 1000 (e.g., in the second set of the two consecutive sets, the second set including two openings 1004 and a cavity 1006). The short end of the second tire tread 1044 extends above the side rail connector 1000 and is located in the space partially defined between the second set and the first set. The long section of the second tire tread 1044 extends horizontally away from the bottom of the side rail connector 1000 in a direction opposite that of the long section of the first tire tread 1042.

The friction between the first tire tread 1042 and the cross-pieces 1014 and 1016 with which the first tire tread 1042 engages, the friction between the second tire tread 1044 and the cross-pieces 1014 and 1016 with which the second tire tread 1044 engages, and the friction between the short ends of the first and second tire treads 1042 and 1044 prevent movement and separation of the first tire tread 1042 and the second tire tread 1044.

As described above, the side rail connector 1000 for adjoining the first tire tread 1042 and the second tire tread 1044 comprises: a first side rail 1002, a second side rail 1002, and at least six cross pieces (four cross pieces 1014 and two cross pieces 1016). A first end of each cross piece is installed in a perpendicular orientation to the same side of the first side rail 1002 with each cross piece positioned apart on the first side rail 1002 so that there is adequate space between each cross piece for a tire tread, a second end of each cross piece is installed in a perpendicular orientation to the same side of the second side rail 1002. Further, two adjacent cross pieces of the six cross pieces are positioned apart so that there is adequate space between the two cross pieces for the first and second tire treads 1042 and 1044. The first tire tread 1042 is positioned in a first direction longitudinal to the first and the second side rails 1002 and is wound about at least three cross pieces of the six cross pieces in a serpentine orientation. Similarly, the second tire tread 1044 is positioned in a second direction opposite to the first direction longitudinal to the first and the second side rails 1002 and is wound about at least the remaining three cross pieces of the six cross pieces in a serpentine orientation.

The side rail connector 1000 of FIGS. 7A-7C can be assembled at a dedicated manufacturing facility, or optionally can be assembled at the site of deployment, thereby providing options for deployment of the embodiments in accordance with the needs of the user, and the location for the deployment. Additionally, the assembly may be distributed between the manufacturing facility and the site of deployment. For example, the side rails 1002 with the installed cross-pieces 1014 and 1016 can be assembled in the manufacturing facility and delivered to the site of deployment where the tire treads 1042 and 1044 are cut and installed in the side rail connector 1000.

In an embodiment, a combination of the herein above described connectors may be used to connect a plurality of tire treads (e.g., to form a chain of tire treads, to form a web of tire treads, etc.) and to connect the tire treads to a plurality of structures (e.g., connect a tire tread at one end of a chain of tire treads to a MSE panel and connect a tire tread at the other end of the chain to another or same MSE panel). To illustrate, the connector 700 of FIG. 4 can be configured to connect a first tire tread to the manufactured facing panel 707. The connector 300 of FIG. 1 may be configured to connect the first tire tread to a second tire tread. Also, the connector 400 of FIG. 2 may be configured to connect the second tire tread to a third tire tread. Continuing with this chaining, the connector 500 of FIG. 3 may be configured to connect the third tire tread to a fourth tire tread and connector 1000 of FIGS. 7A-7C may be configured to connect the fourth tire tread to a fifth tire tread. To connect the fifth tire tread to a crib wall, the connector 800 of FIG. 5 may be used. To connect the fifth tire tread to a temporary retaining wall instead, the connector 900 of FIG. 65 may be used. This example is merely illustrative. One having ordinary skill in the art will appreciate that various other configurations for using the herein above described connectors may be implemented depending on a desired georeinforcing configuration.

In a further embodiment, the combination of the herein above described connectors can be assembled at a dedicated manufacturing facility, or optionally can be assembled at the site of deployment, thereby providing options for deployment of the embodiments in accordance with the needs of the user, and the location for the deployment. Additionally, the assembly may be distributed between the manufacturing facility and the site of deployment. For example, the various components of the connectors can be assembled in the manufacturing facility and delivered to the site of deployment where the tire treads are cut and installed in using these various pre-assembled components.

While the present disclosure illustrates and describes a preferred embodiment and several alternatives, it is to be understood that the techniques described herein can have a multitude of additional uses and applications. Accordingly, the invention should not be limited to just the particular description and various drawing figures contained in this specification that merely illustrate various embodiments and application of the principles of such embodiments.

What is claimed:

1. A tire tread connector for adjoining a first tire tread and second tire tread comprising: a first clamp piece having an outer surface and an inner serrated surface, the first clamp piece forming a first clamp piece bolt hole, a second clamp piece having an outer surface and an inner serrated surface, the second clamp piece forming a second clamp piece bolt hole and a clamp bolt, wherein an end the first tire tread is positioned adjacent but not in contact to an end of the second tire tread, the inner serrated surface of the first clamp piece is placed on a first side of the first tire tread and a first side of the second tire tread, the serrated inner surface of the second clamp piece is placed on a second side of the first tire tread and a second side of the second tire tread, and the clamp bolt is positioned through the first clamp piece bolt hole and the second clamp piece bolt hole holding the first tire tread and the second tire tread between the first clamp piece and the second clamp piece.

2. A tire tread connector for adjoining a first tire tread and a second tire tread comprising: a spacer, a first load bar, a second load bar, a first load bar clamp, and a second load bar clamp, wherein a first end of the first load bar and a first end of the second load bar are affixed in a perpendicular orientation to the same side of the first load bar clamp where the first load bar and the second load bar are positioned along the first load bar clamp so that there is sufficient spacing for at least twice the combined thickness of the first tire tread and the second tire tread, a second end of the first load bar and a second end of the second load bar are affixed in a perpendicular orientation to the same side of the second load bar clamp, and wherein the first tire tread is positioned between the spacer and the first load bar, wrapped around the spacer, and positioned between the spacer and the second load bar with a first end of the first tire tread positioned beyond and approximately parallel to the second load bar, the second tire tread is positioned between first tire tread and the second load bar, wrapped around the spacer, and positioned between the first tire tread and the first load bar with the first end of the second tire tread positioned beyond and approximately parallel to the first load bar.

3. A tire tread connector for adjoining a first tire tread and a second tire tread comprising: a first end piece, a second end piece, and at least three cross pieces, wherein a first end of each cross piece is affixed in a perpendicular orientation to the same side of the first end piece with each cross piece positioned apart on the first end piece so that there is adequate space between each cross piece for a tire tread, and a second end of each cross piece is affixed in a perpendicular orientation to the same side of the second end piece, wherein the first tire tread is positioned in a first direction longitudinal to the first and the second end pieces where the first tire tread is wound about at least two cross pieces in a serpentine orientation, and the second tire tread is positioned in a second direction opposite to the first direction longitudinal to the first and the second end pieces where the second tire tread is wound about at least two cross pieces in a serpentine orientation.

4. A tire tread connector for adjoining a tire tread to a mechanically stabilized embankment facing panel comprising:
a first end piece,
a second end piece,
an anchor cross piece having two tabs extending in opposite directions perpendicularly from the body of the anchor cross piece,
at least two cross pieces,
a first angle shaped tab and second angle shaped tab, wherein each angle shaped tab has a long axis portion, and a short axis portion where the short axis portion is shorter than the long axis portion and is perpendicular to the long axis portion,
wherein a first end of the body of the anchor cross piece is affixed in a perpendicular orientation at the first end to a first side of the first end piece so that the two tabs extend orthogonally above and below the plane formed by the body of the anchor cross piece and the first end piece, a first end of each cross piece is affixed in a perpendicular orientation to the first side of the first end piece where each cross piece is positioned relative to each adjacent cross piece so that there is sufficient space for the tire tread, a second end of the anchor cross piece and a second end of each cross piece are affixed in a perpendicular orientation to the same side of the second end piece, the first angle shaped tab is adjoined at the end of the long axis portion to the read side of the mechanically stabilized embankment facing panel with the short axis portion pointing downward, the second angle shaped tab is adjoined at the end of the long axis portion to the read side of the mechanically stabilized embankment facing panel below the first angle shaped tab with the short axis portion facing upward, the second angle shaped tab is positioned below the first angle shaped tab such that the tire tread and the body of the anchor piece can fit between the first angle shaped tab and the second angle shaped tread, the tire tread is positioned in a direction longitudinal to the first and the second end pieces where the tire tread is wound about at least two cross pieces in a serpentine orientation with a end of the tire tread positioned near one of the tabs extending perpendicularly from the body of the anchor cross piece, and the tabs extending from the anchor cross piece fit between the read side of the mechanically stabilized embankment facing panel and the short axis portion of the first shaped angle tab and short axis portion of the second shaped angle tab.

5. A tire tread connector for adjoining a tire tread to a modular block retaining wall or a crib wall comprising:
a first end piece,
a second end piece,
an anchor cross piece having one leg extending in a perpendicular direction from the body of the anchor cross piece, and
at least two cross pieces,
wherein a first end of the body of the anchor cross piece is affixed in a perpendicular orientation at the first end to a first side of the first end piece so that the leg extends orthogonally below the plane formed by the body of the anchor cross piece and the first end piece, a first end of each cross piece is affixed in a perpendicular orientation to the first side of the first end piece where each cross piece is positioned relative to each adjacent cross piece so there is sufficient space for the tire tread, a second end of the anchor cross piece and a second end of each cross piece are affixed in a perpendicular orientation to the same side of the second end piece, the tire tread is positioned in a direction longitudinal to the first and the second end pieces where the tire tread is wound about at least two cross pieces in a serpentine orientation with a end of the tire tread positioned near the leg of the anchor cross piece, and where the leg of the anchor cross piece abuts again the rear of a core hole of the modular block.

6. A tire tread connector for adjoining a tire tread to a whole tire comprising:
a first end piece,
a second end piece,
an anchor cross piece having a body portion and a leg having a long axis portion that extends in first perpendicular direction relative to the body of the anchor cross piece, and a short axis portion then extends in a second perpendicular direction relative to the first perpendicular direction so that the short axis is parallel with anchor cross piece,
at least two cross pieces,
wherein a first end of the body of the anchor cross piece is affixed in a perpendicular orientation at the first end to a first side of the first end piece so that the leg extends orthogonally below the plane formed by the body of the anchor cross piece and the first end piece, a first end of each cross piece is affixed in a perpendicular orientation to the first side of the first end piece where each cross piece is positioned relative to each adjacent cross piece so that there is sufficient space for the tire tread, a second end of the anchor cross piece and a second end of each cross piece are affixed in a perpendicular orientation to the same side of the second end piece, the tire tread is positioned in a direction longitudinal to the first and the second end pieces where the tire tread is wound about at least two cross pieces in a serpentine orientation with a end of the tire tread positioned near the leg of the anchor cross piece, and where the long axis portion of the leg abuts against the inside portion of the bead of the whole tire, and the short axis portion is adjacent to the interior surface of the whole tire.

7. A tire tread connector for adjoining a first tire tread and a second tire tread comprising:
a first end piece;
a second end piece; and
at least six cross pieces, wherein a first end of each cross piece is installed in a perpendicular orientation to the same side of the first end piece with each cross piece positioned apart on the first end piece so that there is adequate space between each cross piece for a tire tread, a second end of each cross piece is installed in a perpendicular orientation to the same side of the second end piece, wherein two adjacent cross pieces of the six cross pieces are positioned apart so that there is adequate space between the two cross pieces for two tire treads, and wherein the first tire tread is positioned in a first direction longitudinal to the first and the second end pieces where the first tire tread is wound about at least three cross pieces of the six cross pieces in a serpentine orientation, and the second tire tread is positioned in a second direction opposite to the first direction longitudinal to the first and the second end pieces where the second tire tread is wound about at least the remaining three cross pieces of the six cross pieces in a serpentine orientation.

8. A system for providing georeinforcing elements, the system comprising:
a plurality of tire treads;
a first connector having at least a portion of a first tire tread among the plurality of tire treads wound through the first connector in a serpentine fashion; and
a second connector configured to connect to a structure, wherein the first connector is connected to the second connector.

9. The system of claim 8, wherein the structure is any one of a modular block, a crib wall, a mechanically stabilized embankment facing panel, or a tire.

10. The system of claim 8, wherein the first tire tread has a first end and a second end, the first end being would through the first connector, further comprising a third connector having the second end of the first tire tread wound through the second connector in the serpentine fashion.

11. The system of claim 10, further comprising a series of additional connectors for joining one or more tire treads among the plurality of tire treads in a chain connected to the third connector.

12. The system of claim 8, wherein a second tire tread among the plurality of tire treads is wound through the first connector in the serpentine fashion.

13. The system of claim 8, further comprising a series of additional connectors for joining one or more tire treads among the plurality of tire treads in a chain connected to the first connector.

14. The system of claim 8, wherein the first connector and the second connector are made of non-corrosive materials.

15. The system of claim 8, wherein the first connector, the second connector, and the plurality of tire treads are assembled at a deployment site where the georeinforcing elements are provided.

16. The system of claim 8, wherein the first connector and the second connector are assembled at a manufacturing facility, and wherein the plurality of tire treads are connected to the first connector and the second connector at a deployment site where the georeinforcing elements are provided.

17. The system of claim 8, wherein the plurality of tire treads are obtained from used tires.

18. The system of claim 8, wherein the first connector, the second connector, and the plurality of tire treads are installed at a deployment site where the georeinforcing elements are provided, wherein the installation eliminates uses of anti-corrosive measures at the deployment site, and wherein the uses of anti-corrosive measures comprise uses of treated pH neutral backfill.

19. The system of claim 8, wherein when the first connector, the second connector, and the plurality of tire treads are first installed at a first deployment site and subsequently removed from the first deployment site, the first connector, the second connector, and the plurality of tire treads are recovered and reused in a second deployment site.

20. A system for providing georeinforcing elements, the system comprising:
a plurality of tire treads;
means for connecting at least two tire treads of the plurality of tire treads by way of applying tensile forces to the at least two tire treads and of causing friction between the at least two tire treads; and
means for connecting a tire tread of the at least two tire treads to a structure by way of applying friction to the tire tread.
